(19) United States
(12) Patent Application Publication
(10) Pub. No.: US 2015/0074180 A1
(43) Pub. Date: Mar. 12, 2015

(54) SYSTEM AND METHOD FOR PROVIDING OFFLINE ACCESS TO CONTENT AVAILABLE OVER THE WEB

(71) Applicant: MAINSOFT R&D LTD., Lod (IL)

(72) Inventor: Roy Sheinfeld, Tel Aviv (IL)

(73) Assignee: MAINSOFT R&D LTD., Lod (IL)

(21) Appl. No.: 14/481,222

(22) Filed: Sep. 9, 2014

Related U.S. Application Data
(60) Provisional application No. 61/876,531, filed on Sep. 11, 2013.

(51) Int. Cl. H04L 29/08

(52) U.S. Cl. CPC H04L 67/2842; H04L 67/10; H04L 67/02
USPC 709/203

(57) ABSTRACT

A system and method are provided for offline access to content accessible over a network. The method comprises identifying a grant of access to at least one data source respective of the network, wherein the access is granted to a client node; identifying a data element of one of the at least one data source; determining if the data element is suitable for offline viewing; and upon determining that the data element is suitable to be viewed offline, storing the data element in a storage unit that is accessible to the client node while operating offline.

### CROSS-REFERENCE TO RELATED APPLICATIONS

This application claims the benefit of U.S. Provisional Application No. 61/876,531 filed on Sep. 11, 2013, the contents of which are hereby incorporated by reference.

### TECHNICAL FIELD

The present invention relates generally to accessing data over the web and, in particular, to systems and methods for providing data that exists on web sources while operating offline.

### BACKGROUND

The worldwide web (WWW) offers real-time access to large amounts of information, thereby enabling users to collaborate with colleagues and business partners both inside and outside an organization. Currently, due to the evolution of 3^{rd} generation (3G) and 4^{th} generation (4G) cellular network coverage, many users have constant access to the worldwide web through their mobile or other devices.

However, in spite of this expanding coverage, there are still various situations in which users may not be able to access the WWW. As an example, when users are flying or working in areas which are not yet covered by cellular reception, they may be unable to access the WWW in any form. Although users in such cases cannot access the web, they may still desire to view and/or modify documents available over the web (e.g., documents saved in a cloud storage).

Further, even when users can access content available over the web via mobile devices, such access may require use of 3G and 4G networks. Providers of 3G and 4G networks often limit a user's allowable bandwidth consumption, thereby preventing a user from accessing the network or charging the user an additional fee if the user's allowable bandwidth is exceeded. Thus, even if such users are able to access such networks, they may prefer to work offline whenever possible.

It would therefore be advantageous to provide a solution that would overcome the deficiencies of the prior art by enabling access to content that exists over the web while a user is working offline.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

The disclosure relates in various embodiments to a method for providing offline access to content accessible over a network. The method comprises identifying a grant of access to at least one data source respective of the network, wherein the access is granted to a client node; identifying a data element of one of the at least one data source; determining if the data element is suitable for offline viewing; and upon determining that the data element is suitable to be viewed offline, storing the data element in a storage unit that is accessible to the client node while operating offline.

The disclosure relates in various embodiments to a system for providing offline access to content accessible over a network. The system for providing offline access to content accessible over a network. The system comprises a processor; and a memory, the memory containing instructions that, when executed by the processor, configure the system to: identify a grant of access to at least one data source respective of the network, wherein the access is granted to a client node; identify a data element of one of the at least one data source that has been viewed; determine if the data element is suitable to be viewed offline; and upon determining that the data element is suitable to be viewed offline, store the suitable data element in a storage unit that is accessible to the client node while operating offline.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a system for enabling users to access content that exists over the web while working offline according to an embodiment;

FIG. 2 is a flowchart illustrating providing offline access to content that exists over the web according to an embodiment; and

FIG. 3 is a flowchart illustrating determining suitability of a data element for offline viewing according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

A system analyzes web based online content viewed by a client node. Based on the analysis, the system determines which of one or more data elements viewed are suitable to be viewed while the client node operates offline. The system then stores the suitable data elements in a storage unit accessible by the client node while operating offline.

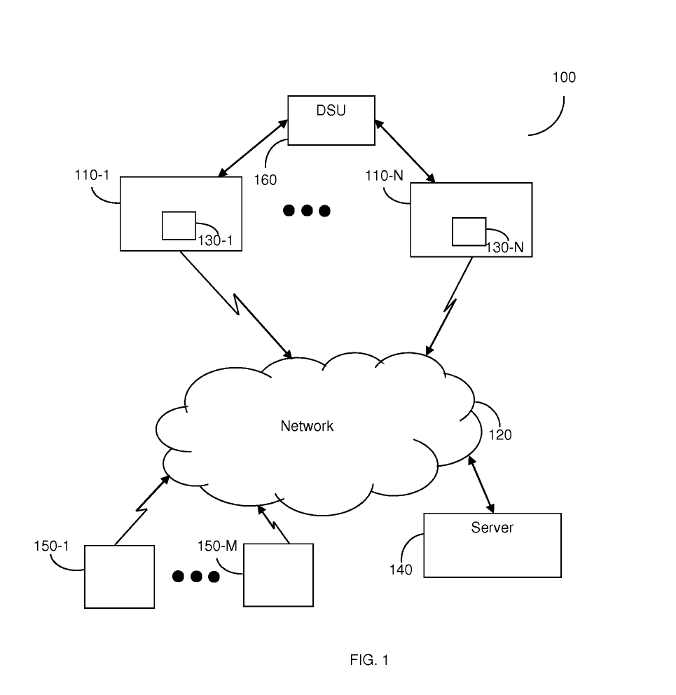

FIG. 1 shows an exemplary and non-limiting schematic block diagram of a system 100 for providing offline access to content that is available over the web according to an embodiment. A plurality of client nodes 110-1 through 110-N (hereinafter referred to collectively as client nodes 110 or individually as a client node 110, merely for simplicity purposes), are communicatively connected to a network 120. The client node 110 may be, but is not limited to, a tablet computer, a laptop computer, a personal computer, a smart phone, and so on. The network 120 may be a wireless, cellular, or wired network, a local area network (LAN), a wide area network (WAN), a metro area network (MAN), the Internet, the worldwide web (WWW), like networks, and any combination thereof.

In one embodiment, the system 100 may be implemented as an application program installed on the client node 110. In one embodiment, each agent of a plurality of agents 130-1 through 130-N (hereinafter referred to collectively as agents 130 or individually as an agent 130) is software code that is installed in a memory of a respective client node 110-1 through 110-N and executed by a processing element of the client node 110. Each agent 130 is communicatively coupled to a server 140 over the network 120.

An agent 130, for example agent 130-1, is configured to identify data elements viewed by the client node 110 in one or more data sources 150-1 through 150-M (hereinafter referred to collectively as data sources 150 or individually as a data source 150, merely for simplicity purposes) over the network 120. Such data elements may be, but are not limited to, documents, images, video clips, and combinations thereof.

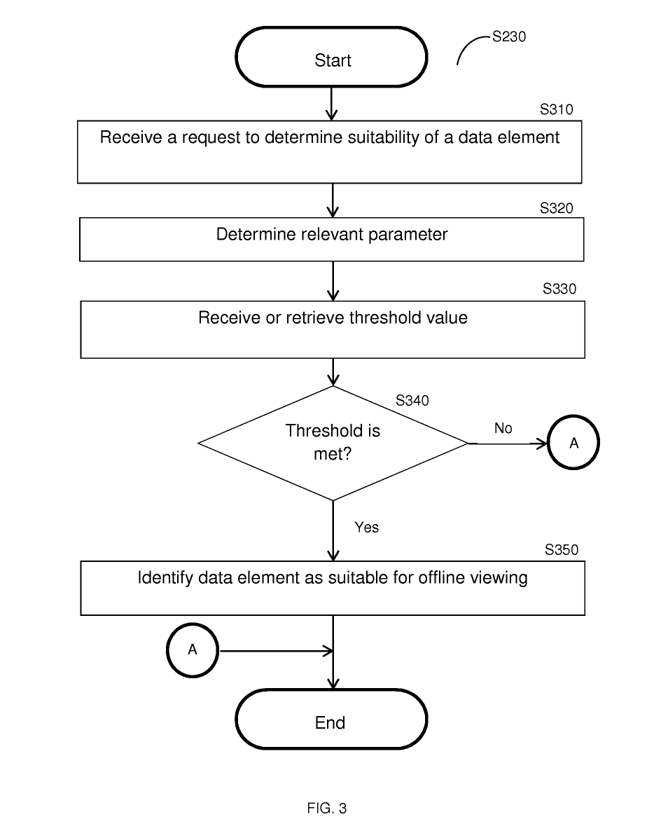

The agent 130, for example agent 130-1, is further configured to analyze such data elements. Through the analysis, the agent 130-1 continuously queries the data sources 150. Respective of the querying, the server 140 identifies metadata related to the data elements viewed by the client node. Such metadata may be, for example, the type of the content, changes made to the content, and so on. Respective of the analysis, the agent 130-1 is configured to determine which of the data elements viewed by the client node 110 is suitable to be viewed when the client node 110 operates offline. As a non-limiting example, if the data element has not been changed for a certain predetermined time, it may be considered as suitable to be viewed while operating offline because it is less likely that an online update will be required for such a data element. Determination of suitability is described further herein below with respect to FIG. 3.

The agent 130-1 stores the suitable data elements in a data storage unit (DSU) 160 accessible by the client node 110 while operating offline. The data storage unit 160 may be, for example, a cache memory unit. In an embodiment, the DSU 160 may be implemented within the client node 110. The analysis of the data elements as well as the determination of whether the content is suitable to be viewed when the client node 110 operates offline may be made by the server 140 and sent to the DSU 160. By storing the data elements in the DSU 160, the system 100 allows the client device 110 to view data elements existing over the network 120 while the client device 110 operates offline.

According to another embodiment, upon identification of a grant of access to at least one data source 140 by a client node 110 over the network 120, the content stored in the storage unit is matched to the same content existing over the network 120 in order to identify changes within the content and to check whether the content is still suitable to be viewed while operating offline. Upon identification of a change in the content or suitability of the content, a notification may be generated and sent to the client node 110.

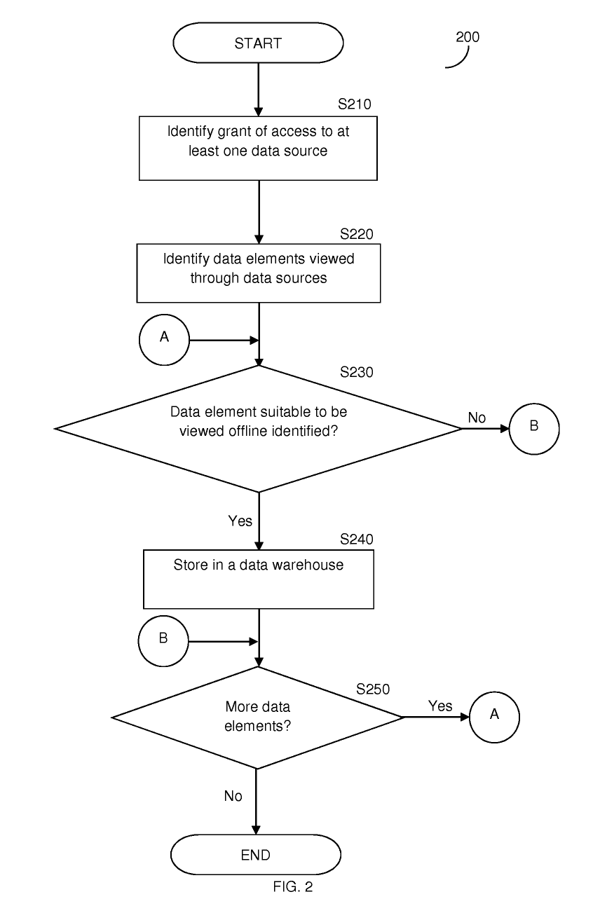

FIG. 2 depicts an exemplary and non-limiting flowchart 200 illustrating providing offline access to content that exists over the web according to an embodiment. In S210, it is a grant access to at least one data source by a client node such as, for example, the client node 110, is identified. In S220, one or more data elements that are viewed through the at least one data source are identified. In S230, it is checked whether one or more of the data elements are suitable to be viewed while operating offline and, if so, execution continues with S240; otherwise, execution continues with S250.

According to one embodiment, the determination of suitability is made based on an analysis of one or more threshold values. Different threshold values may be used for different types of content. As an example of a threshold, upon determining that a data element has not been changed in at least a certain period of time, such content is determined as static and, therefore, suitable.

As a non-limiting example, a threshold for suitability may be a time since last change greater than 5 minutes. In such an example, if the content has been updated or otherwise changed 2 minutes ago, such content may be determined to be dynamic. In some embodiments, content may be suitable to be viewed while operating offline if it is static. Dynamic content such as, for example, rich site summary (RSS) feeds, multimedia content, and so on, tends to change frequently and therefore requires active updates from the network 120. Dynamic content is not typically suitable to be viewed while operating offline.

In S240, the one or more suitable data elements are stored in a data storage unit (e.g., the DSU 160) accessible by the client node while operating offline. In S250, it is checked whether additional data elements are viewed and, if so, execution continues with S230; otherwise, execution terminates.

As a non-limiting example, a grant of access to an e-mail account over a network (e.g., the network 120) is identified. The user's calendar is identified as content within the e-mail account. In this example, the content is determined as static if it has not been updated in the past 3 minutes. Additionally, in this example, content is suitable if it is static. It is determined that the calendar was most recently updated 3 hours ago. Thus, the calendar is determined to be static and, therefore suitable content. Respective thereto, the calendar is then saved in a data storage unit (e.g., the DSU 160). Upon identification of a subsequent grant of access to the e-mail account, it is checked whether the calendar is updated.

FIG. 3 is an exemplary and non-limiting flowchart S230 illustrating determination of suitability of a data element for offline viewing according to an embodiment. In S310, a request to determine whether a data element is suitable for offline viewing is received. In S320, one or more relevant parameters respective of the data element is determined. As a non-limiting example, such a parameter may be the time since the last change to the data element. The parameter may also be a time pointer associated with a data element viewed on the client node. If prior to switching to offline, a certain data element was viewed, such data element or portion thereof may be determined as suitable for offline viewing. According to another embodiment, a size of a data element may also be treated as a parameter indicative of the suitability of that data item to be viewed offline. As an example, a spreadsheet above a certain size shall be determined as suitable to be viewed offline.

According to another embodiment, the agent 130 is configured by the server 140 to monitor a user behavior in the offline mode in order to identify a variety of user's interactions with data content. The interactions may be indicative of changes made to data content based on the amount of recent changes to the data content. The monitored and learnt user behavior can be later used for determining which data elements are suitable of a data element for offline viewing.

In S330, a threshold value is received or retrieved. The threshold value may be, but is not limited to, an amount of time. In S340, it is determined whether the relevant parameter meets the threshold. If so, execution continues with S350; otherwise, execution terminates. In S350, the data element is identified as suitable for offline viewing.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A computerized method for providing offline access to content accessible over a network, comprising:
identifying a grant of access to at least one data source respective of the network, wherein the access is granted to a client node;
identifying a data element of one of the at least one data source;
determining if the data element is suitable for offline viewing; and
upon determining that the data element is suitable to be viewed offline, storing the data element in a storage unit that is accessible to the client node while operating offline.

2. The computerized method of claim 1, wherein the network is any of: a wireless network, a cellular network, a wired network, a local area network (LAN), a wide area network (WAN), a metro area network (MAN), the Internet, the worldwide web (WWW), and a combination thereof.

3. The computerized method of claim 1, wherein the client node is any of:
a tablet computer, a laptop computer, a smart phone, and a personal computer.

4. The computerized method of claim 1, further comprising:
identifying a reconnection to the network;
matching the suitable data element that is stored in the storage unit to a data element that exists over the web; and
upon identifying a change in the data element that exists over the web, generating a notification.

5. The computerized method of claim 1, wherein determining if the data element is suitable for offline viewing further comprises:
determining a parameter respective of the data element;
comparing the determined parameter to a threshold parameter; and
based on the comparison results determining if the data element is suitable for offline viewing.

6. The computerized method of claim 1, wherein the parameter is at least one of: a time pointer, a size of the data element, and a user behavior.

7. A non-transitory computer readable medium having stored thereon instructions for causing one or more processing units to execute the method according to claim 1.

8. A system for providing offline access to content accessible over a network, comprising:
a processor; and
a memory, the memory containing instructions that, when executed by the processor, configure the system to:
identify a grant of access to at least one data source respective of the network, wherein the access is granted to a client node;
identify a data element of one of the at least one data source that has been viewed;
determine if the data element is suitable to be viewed offline; and
upon determining that the data element is suitable to be viewed offline, store the suitable data element in a storage unit that is accessible to the client node while operating offline.

9. The system of claim 8, wherein the network is any of: a wireless network, a cellular network, a wired network, a local area network (LAN), a wide area network (WAN), a metro area network (MAN), the Internet, the worldwide web (WWW), and a combination thereof.

10. The system of claim 8, wherein the system is further configured to:
identify a reconnection to the network;
match the suitable data element that is stored in the storage unit to a data element that exists over the web; and
upon identifying a change in the data element that exists over the web, generate a notification.

11. The system of claim 8, wherein the system is further configured to:
determine a parameter respective of the data element;
compare the determined parameter to a threshold parameter; and based on the comparison results determining if the data element is suitable for offline viewing.

12. The system of claim 11, wherein the determined parameter is at least one of: a time pointer, a size of the data element, and a user behavior.
